(19) United States
(12) Patent Application Publication
(10) Pub. No.: US 2016/0182491 A1
(43) Pub. Date: Jun. 23, 2016

(54) METHODS, SYSTEMS AND APPARATUS TO MANAGE AN AUTHENTICATION SEQUENCE

(71) Applicants: Lichun Jia, Beaverton, OR (US); Craig T. Owen, Folsom, CA (US); Kevin C. Cheng, Elk Grove, CA (US); Ned M. Smith, Beaverton, OR (US); Abhilasha Bhargav-Spantzel, El Dorado Hills, CA (US); Dave P. Singh, Portland, OR (US)

(72) Inventors: Lichun Jia, Beaverton, OR (US); Craig T. Owen, Folsom, CA (US); Kevin C. Cheng, Elk Grove, CA (US); Ned M. Smith, Beaverton, OR (US); Abhilasha Bhargav-Spantzel, El Dorado Hills, CA (US); Dave P. Singh, Portland, OR (US)

(21) Appl. No.: 14/581,277

(22) Filed: Dec. 23, 2014

(51) Int. Cl. H04L 29/06

(52) U.S. Cl. CPC H04L 63/0823; H04L 63/10

(57) ABSTRACT

Methods, apparatus, systems and articles of manufacture are disclosed to manage an authentication sequence. An example disclosed apparatus includes a verification engine to verify whether a platform policy sequence is authorized for the platform, when the platform policy sequence is authorized, a policy sequence engine to extract an ordered sequence of credential types from the platform policy sequence, in response to a platform log in request, a platform instruction engine to transmit an instruction for a first one of the credential types associated with a first sequence position of the platform policy sequence, to determine whether a response to the instruction contains a value indicative of the first credential type, and when the response contains the value indicative of the first credential type, comparing the value to a first threshold confidence value, and a platform authorization engine to unlock platform functionality when the value indicative of the first credential type satisfies the first threshold confidence value.

### FIELD OF THE DISCLOSURE

This disclosure relates generally to computing device security, and, more particularly, to methods, systems and apparatus to manage an authentication sequence.

### BACKGROUND

In recent years, security breaches have become more frequent. Users of computing devices typically enter a password to gain access to their respective computing device, and some users apply the same password for one or more other services accessed via the computing device. In the event that the user password is revealed, stolen and/or otherwise utilized by an unauthorized person or entity, harm may result from the unauthorized access to the computing device and/or services (e.g., financial accounts).

### BRIEF DESCRIPTION OF THE DRAWINGS

FIG. 1 is a schematic illustration of a system to manage an authentication sequence of a computing device.

FIG. 2 is a schematic illustration of an authentication verification processor of FIG. 1.

FIG. 3 is an example policy sequence used by the example system of FIGS. 1 and 2 to manage an authentication sequence.

FIGS. 4 and 5 are flowcharts representative of example machine readable instructions that may be executed to manage an authentication sequence in a manner consistent with the teachings of this disclosure.

FIG. 6 is a schematic illustration of an example processor platform that may execute the instructions of FIGS. 4 and 5 to implement the example system of FIGS. 1 and 2.

### DETAILED DESCRIPTION

A locked state of a computing device prevents unauthorized users from gaining access to one or more functions of the computing device. Additionally, the locked state of the computing device prevents unauthorized access to information (e.g., files, folders, networks, etc.) that is accessible to users when the computing device is in an unlocked state. When a user of the computing device attempts to gain access to the computing device (e.g., a log in attempt using login credentials), password information is entered by the user to unlock computing device functionality. However, because passwords can be difficult to remember for some users, the same passwords may be used for access to the computing device and/or one or more additional services facilitated by the computing device. Services facilitated by the computing device include, but are not limited to, virtual private network (VPN) services/access, local file system services/access, network file system services/access, database applications and/or cloud-based services.

Passwords have typically been the manner of authentication required for access to a computing device because of one or more requirements imposed by an operating system (OS) of the computing device. The OS provides a user interface (UI) for a candidate user when the computing device is in the locked state, such as a UI having a username field and a password field. Through keyboard entry, the candidate user of the computing device may enter corresponding username and/or password information that is managed by the OS in one or more storage locations of the computing device. However, example methods, apparatus, systems and/or articles of manufacture disclosed herein remove, divert and/or otherwise displace authentication rules imposed by the OS and enable hardware-based authentication sequence control. As such, in response to the OS beginning a log in request (e.g., initiated by a user of the computing device), examples disclosed herein employ trusted hardware to intercept and redirect the OS log in procedures by sending one or more authentication instructions to the OS to obtain a credential type (e.g., obtain credential information from one or more multi-factor authentication input devices) having a corresponding credential confidence value. Additionally, the trusted hardware instructs the OS to obtain the credential type in a particular sequence. In the event the OS responds with a credential type that is inconsistent with the particular sequence, the computing device is locked to prevent access by the candidate user.

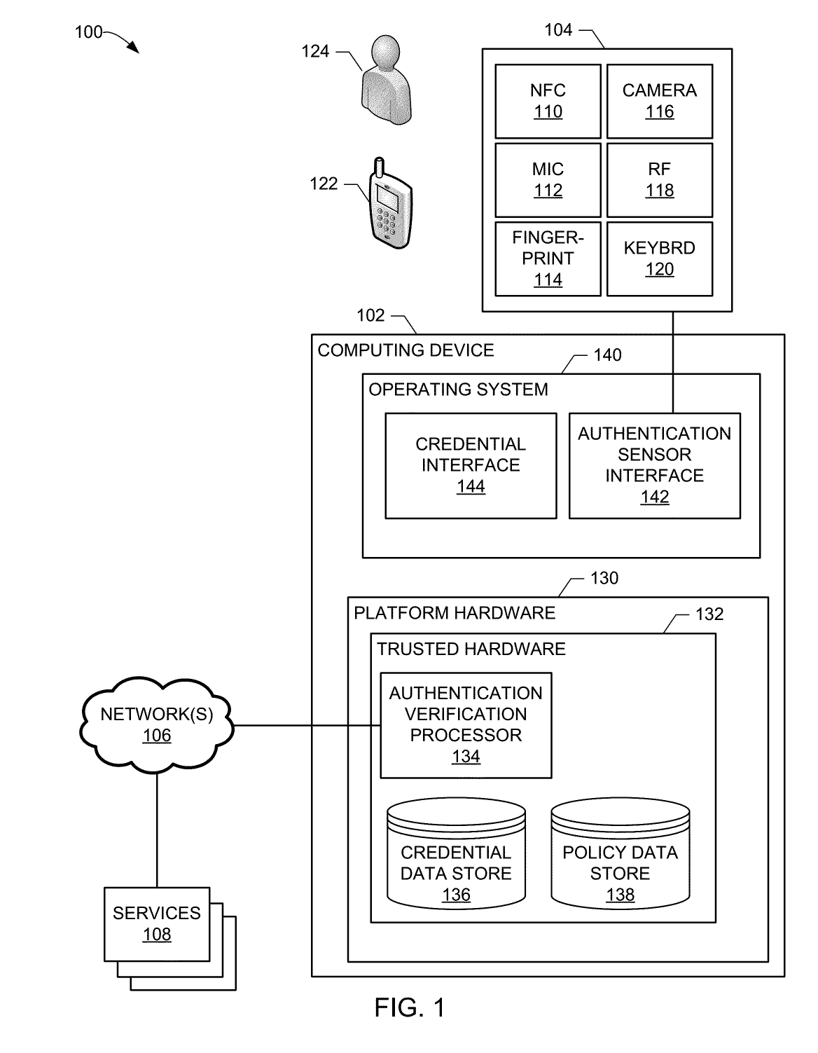

FIG. 1 is an example system 100 to manage an authentication sequence of a computing device/platform 102. In the illustrated example of FIG. 1, the computing device 102 is communicatively connected to authentication sensors 104 and a network 106, such as an intranet and/or the Internet. The example network 106 may be communicatively connected to one or more services 108, such as financial institutions, VPN services and/or business services.

The example authentication sensors 104 include a near field communications (NFC) transceiver 110, a microphone 112, a fingerprint reader 114, a camera 116, a radio frequency (RF) transceiver 118 and a keyboard 120. While six (6) sensor types are shown with the example authentication sensors 104, additional and/or alternative sensor types may be considered, without limitation. In some examples, the NFC transceiver 110 interacts with a wireless device 122 of the candidate user to provide a first credential type having an indication of authentication (e.g., a model number of the wireless device 122, a serial number of the wireless device 122, etc.) associated with a candidate user 124.

Rather than rely on a single credential type to determine whether the candidate user 124 is authorized to use one or more services of the example computing device 102, the example keyboard 120 allows one or more passwords to be entered as a second credential type, and the example microphone 112 captures voice information from the candidate user 124 as a third credential type. In the event that the first credential type (e.g., the information acquired from the example NFC transceiver 110), the second credential type (e.g., the information acquired from the example keyboard 120), and the third credential type (e.g., the information acquired from the example microphone 112) match expected values and are acquired and/or otherwise received in an expected sequence order, then the example candidate user 124 is deemed to be authorized to utilize one or more services of the example computing device 102.

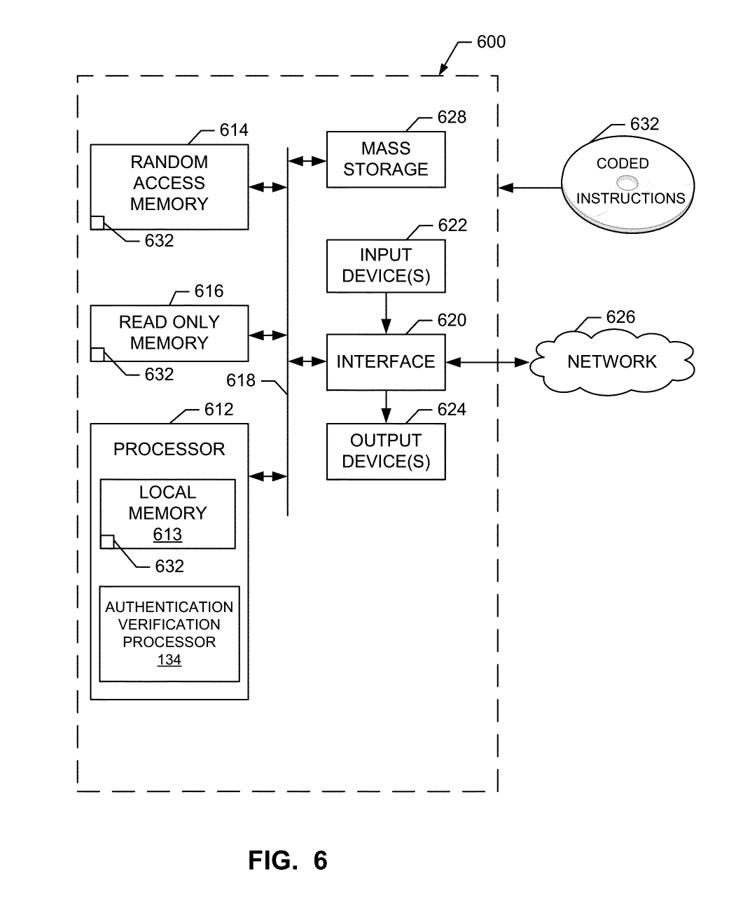

In the illustrated example of FIG. 1, the computing device 102 (sometimes referred to herein as a platform) includes platform hardware 130 that includes one or more processors, memory, network interface(s) and/or disk storage, as described in further detail below in connection with FIG. 6. The example platform hardware 130 also includes trusted hardware 132, which includes an example authentication verification processor 134, an example credential data store 136, and an example policy data store 138. As described in further detail below, the example policy data store 138 contains one or more authentication policy sequence(s) that identify which credential types are required for log in, which order the credential types are to occur, and corresponding values (e.g., threshold values, threshold confidence percentage values, etc.) for each credential type. In the event a proper sequence of credential types is obtained from an OS 140 having acceptable values, then the example authentication verification processor 134 unlocks the computing device 102 for use by the candidate user 124 and/or releases credential information stored in the example credential data store 136. In some examples, the credential information stored in the credential data store 136 includes username and/or password information for third party services 108 (e.g., financial accounts, cloud-based services, etc.) that can be transmitted via the network 106, thereby bypassing access and/or exposure to an operating system (OS) 140 of the computing device 102.

The example platform hardware 130 facilitates execution of the example operating system (OS) 140 of the computing device 102. The example OS 140 includes an authentication sensor interface 142 and an example credential interface 144. While the example authentication sensor interface 142 and the example credential interface 144 are shown in the illustrated example of FIG. 1 as part of the OS 140, such representation is shown for descriptive convenience and not limitation. For example, the authentication sensor interface 142 and/or the credential interface 144 may reside and/or operate within the example platform hardware 130 and/or external to the platform hardware 130.

In the illustrated example of FIG. 1, the trusted hardware 132 may be an isolated and protected coprocessor embedded in a motherboard or chipset of the example platform hardware 130. In some examples, the trusted hardware 132 includes its own media access control (MAC) address and/or Internet protocol (IP) address to facilitate out-of-band (00B) communications independent and/or otherwise separate from the example platform hardware 130. As described above, credentials from the example credential data store 136 may be sent via the network 106 from the authentication verification processor 134 in a manner independent from the platform hardware 130 and/or OS 140, thereby preventing access and/or exposure of credential information to the OS 140.

The example trusted hardware 132 may be implemented as the Intel® Management Engine (ME), or in a manner consistent with the Trusted Computing Group (TCG) as a trusted platform module (TPM). In some examples, the trusted hardware 132 includes one or more cryptographic processor(s), secured input/output (I/O), random number generator(s), key generator(s), hash generator(s), platform configuration registers (PCRs), and/or keys (e.g., storage root keys, attestation identity keys, etc.). In still further examples, an administrator of the computing device 102 establishes originating authentication credentials to allow the trusted hardware 132 to accept one or more authentication policies (e.g., one or more policy sequence lists having an ordered list of credential types and corresponding threshold values of acceptance) having an accepted signature of the administrator. Originating authentication credentials may be established by the administrator during an enrollment mode of the example computing device 102, such as the time immediately after powering-up the computing device 102 after the manufacturing process.

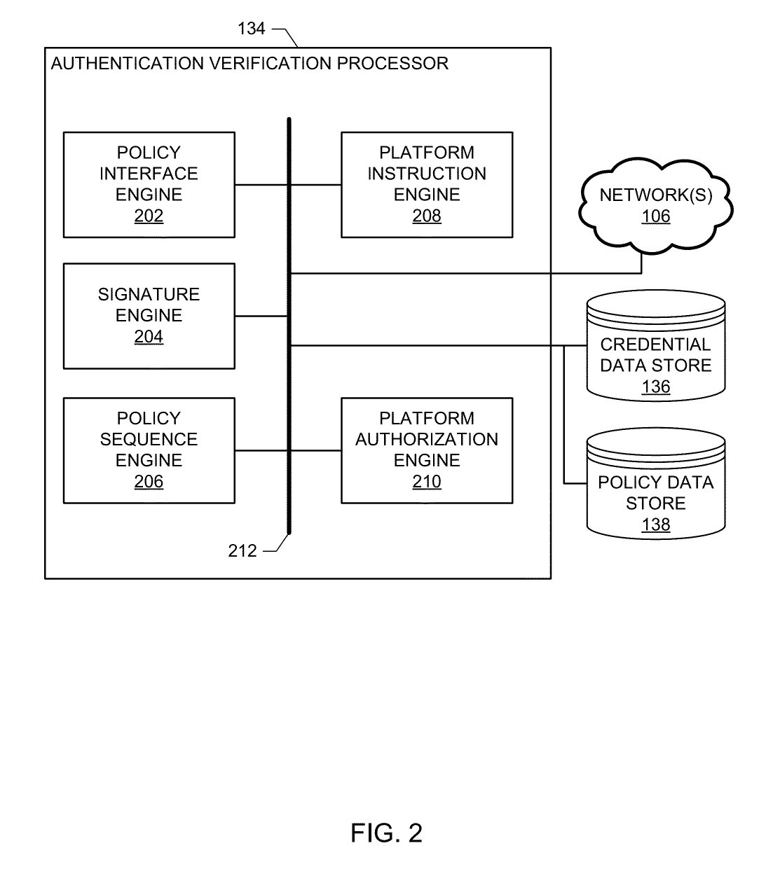

FIG. 2 illustrates additional detail of the example authentication verification processor 134 of FIG. 1. In the illustrated example of FIG. 2, the authentication verification processor 134 includes a policy interface engine 202 communicatively connected to the network 106, a signature engine 204, a policy sequence engine 206, a platform instruction engine 208, a platform authorization engine 210, and a bus 212 to facilitate interconnectivity between components of the authentication verification processor 134 and the policy data store 138 and the credential data store 136.

In operation, the example policy interface engine 202 determines whether an example policy sequence is received or otherwise invoked based on a request to use the example computing device 102. In some examples, an administrator distributes one or more policy sequences (e.g., a list of credential types to be tested and/or otherwise verified in a particular order) to a storage location of each computing device managed by the administrator. In some examples, the storage location is a hard drive of the computing device, and the example policy sequence is signed to ensure that only policy sequences authored by the administrator are applied during authentication of the example computing device 102.

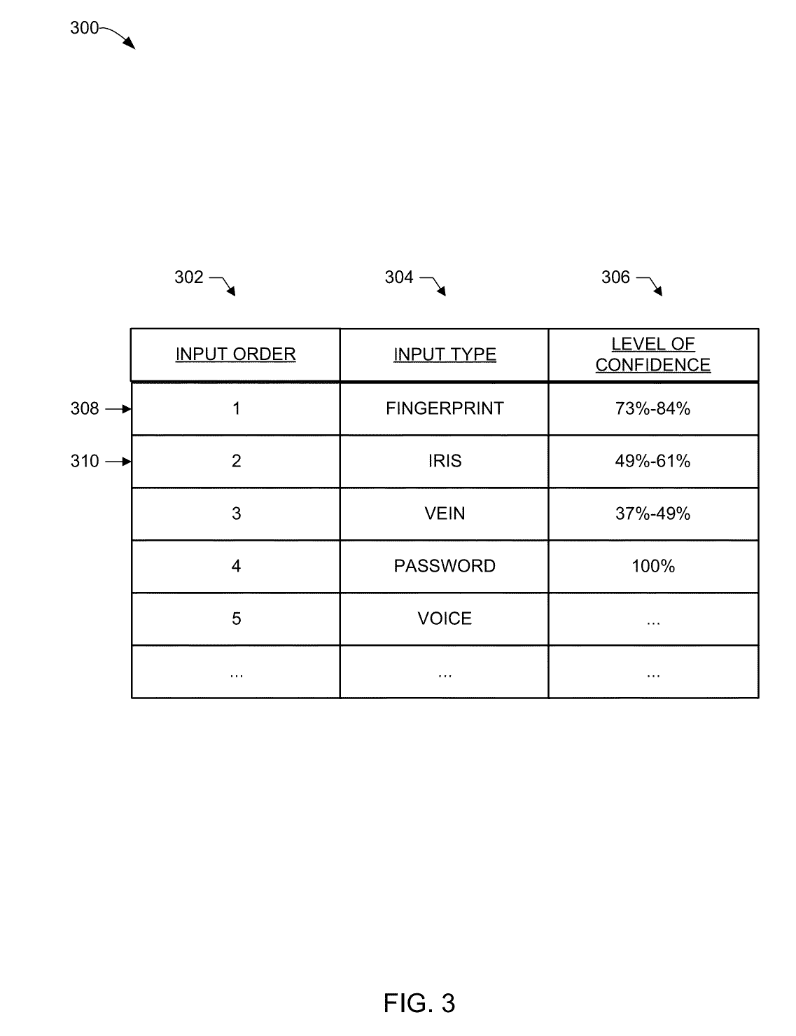

Turning briefly to FIG. 3, an example policy sequence 300 includes an input order column 302, an input type column 304 and a level of confidence column 306. In the illustrated example of FIG. 3, the input order column 302 identifies an ordered sequence for corresponding credential types identified in the input type column 304. As described in further detail below, the example policy sequence 300 serves as instructions to be followed by the example authentication verification processor 134 when determining whether to allow the example candidate user 124 to have access to the computing device 102.

Each credential type in the input type column 304 has a corresponding confidence value identified in the level of confidence column 306 that, when satisfied, indicates that the corresponding input type is deemed acceptable and/or otherwise valid. In some examples, a corresponding confidence value requires a value of 100% satisfaction, such as a password entered via a keyboard. In other words, a password entered via a keyboard is either correct or incorrect. On the other hand, some input types are based on stochastic output values from sensing equipment, such as one or more face detection techniques applied to images captured by the example camera 116, or one or more fingerprint matching techniques applied to data captured by the example fingerprint reader 114. In such stochastic verification techniques, the captured information from one or more sensors results in a probability distribution value that is compared to acceptable values stored in the example credential data store 136, as described in further detail below.

Returning to FIG. 2, after the policy interface engine 202 receives a policy, the example signature engine 204 determines whether the received or identified policy sequence (e.g., the example policy sequence 300 of FIG. 3) is signed. Generally speaking, signing and digital signatures allow messages, files and/or documents to be verified for authenticity, thereby ensuring that the message/file/document is actually authored by the expected party. While the term “signature engine” is described above, example methods, apparatus, systems and/or articles of manufacture disclosed herein may verify messages, files, policies and/or documents in any other manner. Accordingly, the signature engine 204 is sometimes referred to herein as a verification engine 204.

If the policy sequence is either not signed or includes a signature unassociated with one or more authorized signatures associated with the trusted hardware 132 (e.g., the Intel® Management Engine®), the example verification engine 204 rejects further log in attempts for fear that an unauthorized party is attempting to gain access. In some examples, the computing device is locked-down for an amount of time before another logon attempt is permitted. In some examples, the signature engine maintains a list of trusted Certificate Authorities (CA) (e.g., VeriSign®, Thawte®, Symantec®, etc.) and, when one such trusted CA is embedded within the policy sequence, the signature engine 204 applies an attached public key for purposes of decrypting the contents of the policy sequence (e.g., extracting a sequence order of credential types needed for proper platform unlocking). By verifying that the policy sequence is signed with an authorized signature, example methods, apparatus, systems and/or articles of manufacture disclosed herein prevent rogue policy sequences and/or input type confidence values from being used to gain access to the example computing device 102 and/or services 108 accessible to the example computing device 102. If the signature is valid, the example policy sequence engine 206 decrypts the example policy sequence 300 to reveal one or more inputs types, a corresponding order for each input type, and corresponding level of confidence for each input type that must be satisfied to result in acceptance.

The example platform instruction engine 208 determines whether a requestor, such as the example OS 140 and/or the credential interface 144, makes a log in attempt for access to the platform (e.g., computing device) 102. If so, the example platform instruction engine 208 sends an instruction message to the requestor regarding what type of credential input type is to be provided. Using the example policy sequence 300 of FIG. 3 for the sake of illustration, a first credential input type 308 is a fingerprint credential. As such, the example platform instruction engine 208 sends an instruction message to the requestor that fingerprint information of the candidate user 124 is needed. In some examples, the credential interface 144 instructs the authentication sensor interface 142 to invoke the example fingerprint scanner 114 of the authentication sensors 104 and return the result back to the authentication verification processor 134.

If the example platform instruction engine 208 of the example authentication verification processor 134 receives an alternate type of input type from the requestor (e.g., the example credential interface 144 of the example OS 140), then the log in attempt fails and the candidate user 124 is not deemed trustworthy. Generally speaking, examples disclosed herein protect the example platform 102 from unauthorized feature unlocking and/or access in the event a hacker has obtained one or more login credentials associated with the candidate user 124. For example, even if the hacker has obtained a password, an iris credential signature, a vocal signature, etc., if such credential types are not provided in a sequential manner as dictated by a currently used platform policy sequence, then the log in attempt fails as an out-of-order violation. On the other hand, if the example platform instruction engine 208 receives the correct input type (e.g., data from the fingerprint scanner 114), then the value(s) from the input type are compared to the corresponding level of confidence value identified in the level of confidence column 306. If the input type value(s) satisfy the confidence value, then that input type is deemed to pass, and the example platform instruction engine 208 determines whether one or more additional input types are to be tested.

Continuing with the example policy sequence 300 of FIG. 3, the next input type is an iris scan 310. The process of sending an instruction to the example OS 140 regarding a need for a particular input type, obtaining the input type results, and comparing the results to corresponding confidence values repeats for any number of input types listed in the example policy sequence 300. In the event that any one of the input types fails to arrive in the proper order, or in the event that any one of the input types has a value that does not satisfy the confidence value, then the candidate user 124 is not deemed trustworthy.

When all input types listed in the example policy sequence 300 have been tested in the proper order and meet the corresponding confidence values, the example platform authentication engine 210 retrieves encrypted credentials from the example credential data store 136, and the example signature engine 204 decrypts the credentials therein for use with one or more services 108. In response to a request by the candidate user 124, now authorized to use the example computing device 102, for access to one or more services 108, the example policy interface engine 202 obtains destination information. Destination information may include network address information to connect to one or more services 108, in which the network address information is represented by a network address or a uniform resource locator (URL). The example policy interface engine 202 sends the decrypted credentials (e.g., cleartext) to the one or more services 108 to enable corresponding functionality of the one or more services 108 to occur. In some examples, the decrypted credentials are sent directly to the one or more services 108 without aid and/or participation from the example OS 140, thereby insulating the OS 140 from any access to the credential information. In still other examples, the decrypted credentials are sent back to the example OS 140 to allow the example OS 140 to forward such credential information to the example service(s) 108.

While the example platform 102 is unlocked for use by the candidate user 124 after a successful authorization in accordance with the example policy sequence 300, the example platform authorization engine 210 determines whether a particular amount of time has elapsed since the last authentication process has occurred. If a particular amount of time has elapsed, then the example platform authorization engine 210 locks-down the example computing device 102 and determines whether an alternate policy sequence is to be used to re-authenticate the example computing device 102. For example, a first policy sequence (e.g., the policy sequence 300 of FIG. 3) may be used when the candidate user 124 initially logs in to the computing device 102 at the beginning of a work day, but an alternate policy sequence is to be used for one or more subsequent log in attempts during that work day. One or more alternate policy sequences may be stored in the example policy data store 138 and applied for authentication activities based on a time-of-day, day-of-week, week-of-year, etc.

In some examples, when the example computing device 102 is unlocked for use by the candidate user 124 after a successful authorization in accordance with the example policy sequence 300, the example policy interface engine 202 determines whether an indication of presence of the candidate user 124 is removed. If so, then the example platform authorization engine 210 locks down the computing device 102. In some examples, the indication of presence is associated with detection of a Bluetooth® signal from the wireless device 122 of the candidate user 124. In still other examples, the indication of presence is associated with detection of an NFC signal from the wireless device 122 of the candidate user 124. In the event that the indication of presence is absent, then the example platform authorization engine 210 locks down the computing device 102 and the example platform authorization engine 210 selects a policy sequence to be used for re-authentication.

While an example manner of implementing the example authentication verification processor 134 of FIG. 1 is illustrated in FIG. 2, one or more of the elements, processes and/or devices illustrated in FIGS. 1 and 2 may be combined, divided, re-arranged, omitted, eliminated and/or implemented in any other way. Further, the example policy interface engine 202, the example signature engine 204, the example policy sequence engine 206, the example platform instruction engine 208, the example platform authorization engine, the example credential data store 136, the example policy data store 138, the example authentication sensor interface 142, the example credential interface 144 and/or, more generally, the example authentication verification processor 134 of FIGS. 1 and 2 may be implemented by hardware, software, firmware and/or any combination of hardware, software and/or firmware. Thus, for example, any of the example policy interface engine 202, the example signature engine 204, the example policy sequence engine 206, the example platform instruction engine 208, the example platform authorization engine, the example credential data store 136, the example policy data store 138, the example authentication sensor interface 142, the example credential interface 144 and/or, more generally, the example authentication verification processor 134 of FIGS. 1 and 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, policy interface engine 202, the example signature engine 204, the example policy sequence engine 206, the example platform instruction engine 208, the example platform authorization engine, the example credential data store 136, the example policy data store 138, the example authentication sensor interface 142, the example credential interface 144 and/or, more generally, the example authentication verification processor 134 of FIGS. 1 and 2 is/are hereby expressly defined to include a tangible computer readable storage device or storage disk such as a memory, a digital versatile disk (DVD), a compact disk (CD), a Blu-ray disk, etc. storing the software and/or firmware. Further still, the example authentication verification processor 134 of FIGS. 1 and 2 may include one or more elements, processes and/or devices in addition to, or instead of, those illustrated in FIGS. 1 and 2, and/or may include more than one of any or all of the illustrated elements, processes and devices.

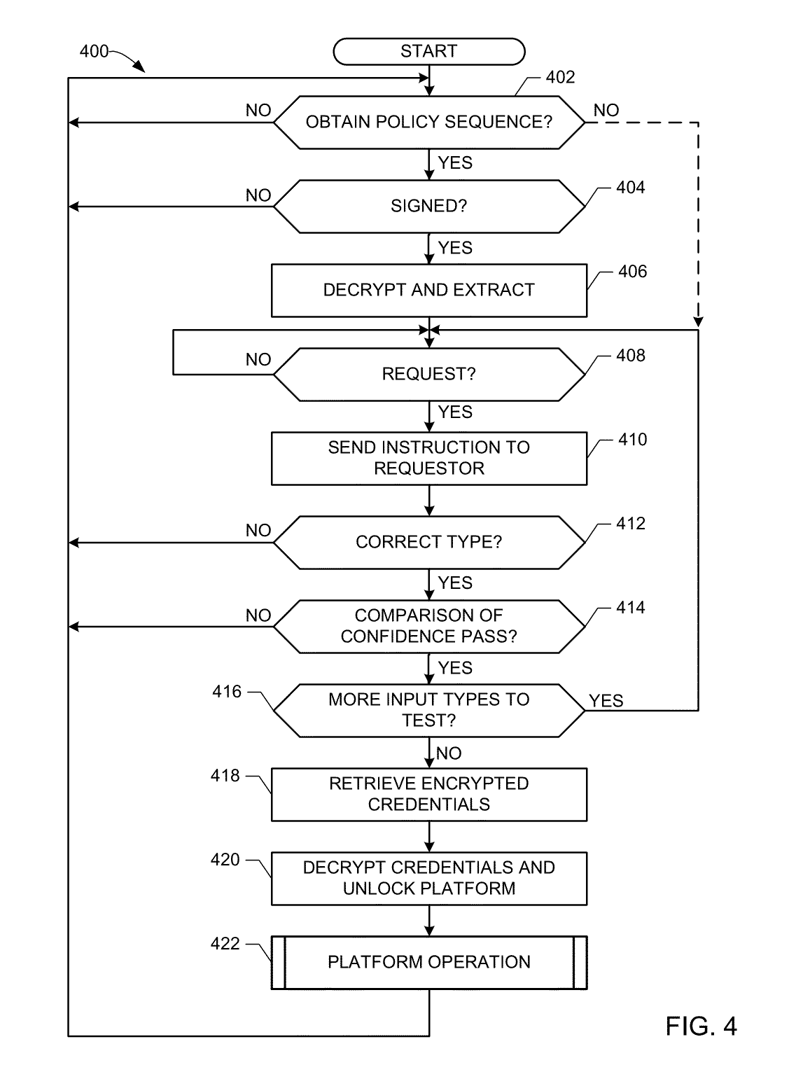

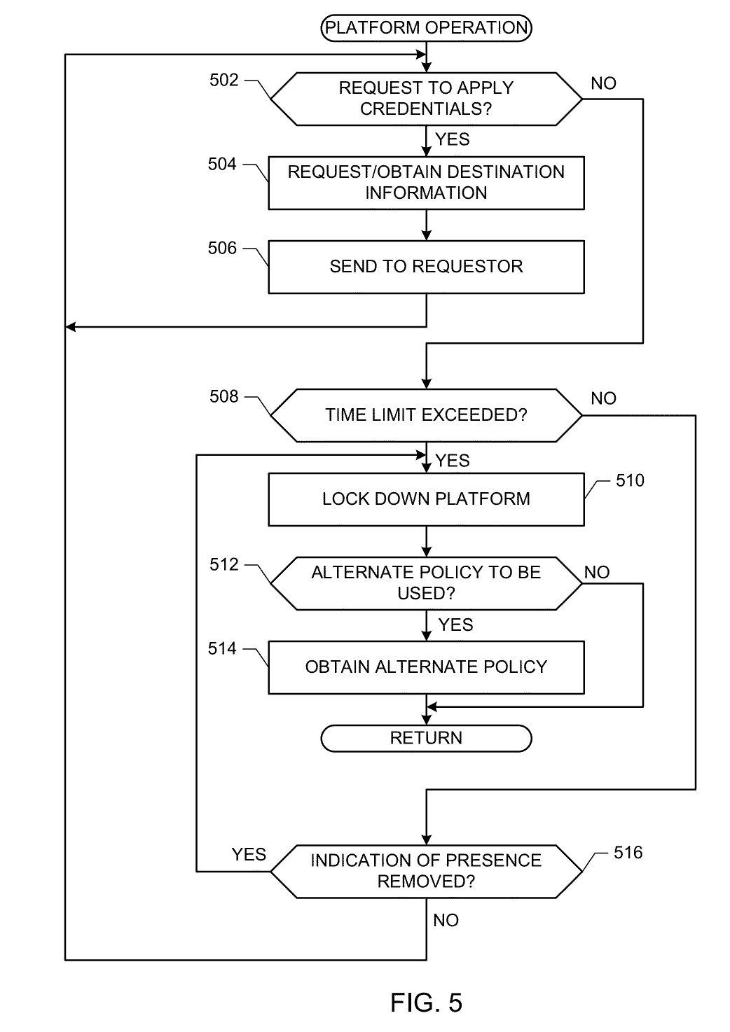

Flowcharts representative of example machine readable instructions for implementing the authentication verification processor 134 of FIGS. 1 and 2 are shown in FIGS. 4-5. In these examples, the machine readable instructions comprise a program for execution by a processor such as the processor 612 shown in the example processor platform 600 discussed below in connection with FIG. 6. The program may be embodied in software stored on a tangible computer readable storage medium such as a CD-ROM, a floppy disk, a hard drive, a digital versatile disk (DVD), a Blu-ray disk, or a memory associated with the processor 612, but the entire program and/or parts thereof could alternatively be executed by a device other than the processor 612 and/or embodied in firmware or dedicated hardware. Further, although the example program is described with reference to the flowcharts illustrated in FIGS. 4-5, many other methods of implementing the example authentication verification processor 134 may alternatively be used. For example, the order of execution of the blocks may be changed, and/or some of the blocks described may be changed, eliminated, or combined.

As mentioned above, the example processes of FIGS. 4-5 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 4-5 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The program 400 of FIG. 4 begins at block 402 where the example policy interface engine 202 determines whether an example policy sequence (e.g., the policy sequence 300 of FIG. 3) is received and/or otherwise invoked based on a request to use the example computing device 102. If not, then the program 400 of FIG. 4 waits for such a request, such as a request by the candidate user 124 via the credential interface 144 of the example OS 140. However, in some examples the program 400 advances to block 408 in the event the example policy sequence 300 has already been received by the example computing device 102, as described in further detail below. When the request is received, retrieved and/or otherwise detected by the example policy interface engine 202 (block 402), the example signature engine 204 determines whether the obtained policy sequence is signed (block 404). If not, then the obtained policy sequence is not to be trusted and the program 400 control returns to block 402 to await another policy sequence. However, if the obtained policy sequence is signed with an authorized signature (block 404), then the example policy engine 206 decrypts the policy sequence and extracts the ordered list contained therein (block 406).

When the example platform instruction engine 208 identifies a request from the requestor (e.g., the candidate user 124 via the OS 140) to log in (block 408), the example platform instruction engine 208 responds with an instruction message regarding what type of credential must be sent (block 410). If the example platform instruction engine 208 receives and/or otherwise obtains a response that is inconsistent with the requested credential type (block 412), then the candidate user 124 is not deemed trustworthy, and control of the program 400 returns to block 402.

As disclosed above, presentation of credential types that are inconsistent with an order/sequence specified by the currently used policy sequence are indicative of an out-of-order violation. However, in the event that the response is consistent with the requested credential type (block 412), then the example platform instruction engine 208 compares the value associated with the obtained credential with one or more levels of confidence (e.g., thresholds) (block 414). If the comparison does not satisfy the one or more levels of confidence (block 414), then the candidate user 124 is not deemed trustworthy, and control of the program 400 returns to block 402. On the other hand, if the comparison satisfies the one or more levels of confidence (block 414), then the example platform instruction engine 208 determines whether one or more additional credential types are to be tested (block 416). As described above in connection with FIG. 3, the example policy sequence 300 may include any number of credential types in the example input type column 304.

When all of the credential types from the example policy sequence 300 have been tested and passed (block 416), the example platform authorization engine 210 retrieves encrypted credentials stored in the example credential data store 136 (block 418). Additionally, the example platform authorization engine 210 unlocks the platform 102, and the example signature engine decrypts the retrieved credentials so that they may be used by the platform 102 (block 420). The example authentication verification processor 134 monitors the computing device 102 during an unlocked state (block 422).

The program 422 of FIG. 5 includes additional detail related to platform operation managed by the example authentication verification processor 134. The example platform authorization engine 210 determines whether a request is made to utilize one or more credentials that have been decrypted and/or otherwise made available to the example candidate user 124 of the computing device 102 (block 502). For example, the candidate user 124 may initiate a request via the OS 140 or via the credential interface 144 to access a financial institution (e.g., a personal bank). The example policy engine interface 202 requests and/or otherwise obtains destination information associated with the financial institution (e.g., www.bank.com) (block 504), and sends corresponding credential information to the financial institution to allow access by the candidate user 124 (block 506). In some examples, the policy engine interface 202 provides the decrypted credential information to one or more third party services without corresponding access by the OS 140 of the platform 102. In some examples, the example policy engine interface 202 provides the decrypted credential information back to the example OS 140 so that it may utilize the credentials as needed. In other words, examples disclosed herein may afford the OS 140 varying levels of trust with decrypted credential information.

In the event that there is no request for credentials to be applied to one or more services (block 502), then the example platform authorization engine 210 determines whether a time limit has been exceeded (block 508). If so, then the example platform authorization engine 210 locks down the computing device 102 to prevent further access to the example candidate user 124 (block 510). In an effort to ensure that the example computing device 102 is protected from unauthorized use, different time limits may be set to force re-authentication procedures to occur. The example platform authorization engine 210 determines whether the re-authentication should proceed in view of an alternate policy sequence 300 (block 512). If so, the example platform instruction engine 208 requests, identifies and/or otherwise obtains the alternate policy sequence (block 514), and the example program 422 returns to block 402 of FIG. 4.

In the event a time limit for re-authentication has not occurred (block 508), the example policy interface engine determines whether an indication of presence has been removed (block 516). As described above, the indication of presence may be determined based on an absence of a Bluetooth signal of the wireless device 122 of the candidate user 124 and/or an absence of a corresponding NFC signal. In some examples, the candidate user 124 leaves the proximity of the example computing device 102 (e.g., to go to lunch, to go to the restroom, etc.), thereby leaving the computing device 102 exposed in an unlocked state. If so, control returns to block 510, where the example platform authorization engine 210 locks down the computing device 102. Re-authentication processes may occur after control advances to block 402 of FIG. 4.

FIG. 6 is a block diagram of an example processor platform 600 capable of executing the instructions of FIGS. 4 and 5 to implement the authentication verification processor of FIGS. 1 and 2. The processor platform 600 can be, for example, a server, a personal computer, a mobile device (e.g., a cell phone, a smart phone, a tablet such as an iPad™), a personal digital assistant (PDA), an Internet appliance, a gaming console, a personal video recorder, a set top box, or any other type of computing device.

The processor platform 600 of the illustrated example includes a processor 612. The processor 612 of the illustrated example is hardware. For example, the processor 612 can be implemented by one or more integrated circuits, logic circuits, microprocessors or controllers from any desired family or manufacturer. The processor 612 also includes the example authentication verification processor 134, which includes the example policy interface engine 202, the example signature engine 204, the example policy sequence engine 206, the example platform instruction engine 208, the example platform authorization engine 210, the example authentication sensor interface 142 and/or the example credential interface 144.

The processor 612 of the illustrated example includes a local memory 613 (e.g., a cache). The processor 612 of the illustrated example is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 may be implemented by flash memory and/or any other desired type of memory device. Access to the main memory 614, 616 is controlled by a memory controller.

The processor platform 600 of the illustrated example also includes an interface circuit 620. The interface circuit 620 may be implemented by any type of interface standard, such as an Ethernet interface, a universal serial bus (USB), and/or a PCI express interface.

In the illustrated example, one or more input devices 622 are connected to the interface circuit 620. The input device(s) 622 permit(s) a user to enter data and commands into the processor 612. The input device(s) can be implemented by, for example, an audio sensor, a microphone, a camera (still or video), a keyboard, a button, a mouse, a touchscreen, a track-pad, a trackball, isopoint and/or a voice recognition system. As described above, the input device(s) may include any type of sensor to assist authentication of the example computing device 102, such as biometric sensor(s) to capture fingerprint information, facial features, vein detection, heartbeat detection, galvanic response(s), etc.

One or more output devices 624 are also connected to the interface circuit 620 of the illustrated example. The output devices 624 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 620 of the illustrated example, thus, typically includes a graphics driver card, a graphics driver chip or a graphics driver processor.

The interface circuit 620 of the illustrated example also includes a communication device such as a transmitter, a receiver, a transceiver, a modem and/or network interface card to facilitate exchange of data with external machines (e.g., computing devices of any kind) via a network 626 (e.g., an Ethernet connection, a digital subscriber line (DSL), a telephone line, coaxial cable, a cellular telephone system, etc.).

The processor platform 600 of the illustrated example also includes one or more mass storage devices 628 for storing software and/or data. Examples of such mass storage devices 628 include floppy disk drives, hard drive disks, compact disk drives, Blu-ray disk drives, RAID systems, and digital versatile disk (DVD) drives.

The coded instructions 632 of FIGS. 4 and 5 may be stored in the mass storage device 628, in the volatile memory 614, in the non-volatile memory 616, and/or on a removable tangible computer readable storage medium such as a CD or DVD.

From the foregoing, it will be appreciated that the above disclosed methods, apparatus, systems and/or articles of manufacture have been disclosed to manage an authentication sequence for a computing device. Rather than rely on an operating system to enforce a manner of log in activity, examples disclosed herein enable an authorized manager of the one or more computing devices to establish a customized authentication sequence. The customized authentication sequence may still utilize the resident operating system to facilitate acquisition of one or more types of authentication input to be used to determine whether a candidate user should receive the privilege of using the computing device. However, security of the computing device(s) are enhanced with any number of different authentication policies designed by personnel responsible for device security, such as information technology professionals.

The following further examples, which include subject matter such as an apparatus to manage an authentication sequence, means for managing an authentication sequence, methods for performing an authentication sequence, and at least one machine-readable medium including instructions that, when executed, cause a machine to manage an authentication sequence.

Example 1 is an apparatus to authenticate a platform, which includes a verification engine to verify whether a platform policy sequence is authorized for the platform. The apparatus includes, when the platform policy sequence is authorized, a policy sequence engine to extract an ordered sequence of credential types from the platform policy sequence, and also includes, in response to a platform log in request, a platform instruction engine to transmit an instruction for a first one of the credential types associated with a first sequence position of the platform policy sequence, to determine whether a response to the instruction contains a value indicative of the first credential type, and when the response contains the value indicative of the first credential type, to compare the value to a first threshold confidence value, and a platform authorization engine to unlock platform functionality when the value indicative of the first credential type satisfies the first threshold confidence value.

Example 2 includes the subject matter of example 1, wherein the platform instruction engine is to prohibit access to platform functionality when the response to the instruction contains a value indicative of a second credential type.

Example 3 includes the subject matter of example 2, wherein the platform instruction engine is to identify an out-of-order credential violation in response to receiving the second credential type.

Example 4 includes the subject matter of example 1, wherein the verification engine is to compare a signature embedded in the platform policy sequence with a trusted certificate authority.

Example 5 includes the subject matter of example 4, wherein the verification engine is to decrypt the platform policy sequence using a public key embedded in the platform policy sequence when the trusted certificate authority is included as an authorized certificate authority.

Example 6 includes the subject matter of example 1, wherein the platform instruction engine is to transmit an instruction for a second one of the credential types associated with a second sequence position of the platform policy sequence in response to confirming satisfaction of the first threshold confidence value.

Example 7 includes the subject matter of example 6, wherein the platform instruction engine is to determine whether a response to the instruction for the second one of the credential types contains a value indicative of the second credential type.

Example 8 includes the subject matter of example 1, wherein the platform instruction engine is to determine whether the response to the instruction is associated with at least one of a fingerprint credential type, an iris credential type, a vein pattern credential type, a password credential type, or a voice recognition credential type.

Example 9 includes the subject matter of example 1, wherein the platform authorization engine is to identify a request to provide third party credentials to a third party service provider.

Example 10 includes the subject matter of example 9, wherein the platform authorization engine is to transmit the third party credentials to the third party service provider without participation by an operating system of the platform.

Example 11 includes the subject matter of example 1, wherein the platform authorization engine is to determine if a time limit has expired since the platform functionality was unlocked.

Example 12 includes the subject matter of example 11, wherein the platform authorization engine is to lock the platform and select an alternate platform policy sequence when the time limit has expired, the alternate platform policy sequence comprising an alternate first one of the credential types associated with the first sequence position.

Example 13 includes the subject matter of examples 1-3, wherein the verification engine is to compare a signature embedded in the platform policy sequence with a trusted certificate authority, and decrypt the platform policy sequence using a public key embedded in the platform policy sequence when the trusted certificate authority is included as an authorized certificate authority.

Example 14 includes the subject matter of example 1 to 3, wherein the platform instruction engine is to transmit an instruction for a second one of the credential types associated with a second sequence position of the platform policy sequence in response to confirming satisfaction of the first threshold confidence value, and to determine whether a response to the instruction for the second one of the credential types contains a value indicative of the second credential type.

Example 15 includes the subject matter of examples 1 to 3, wherein the platform authorization engine is to identify a request to provide third party credentials to a third party service provider, and to transmit the third party credentials to the third party service provider without participation by an operating system of the platform.

Example 16 is a method to authenticate a platform, and includes verifying whether a platform policy sequence is authorized for the platform. The example method also includes, when the platform policy sequence is authorized, extracting an ordered sequence of credential types from the platform policy sequence. Further still, the example method includes, in response to a platform log in request, transmitting an instruction for a first one of the credential types associated with a first sequence position of the platform policy sequence, determining whether a response to the instruction contains a value indicative of the first credential type, and when the response contains the value indicative of the first credential type, comparing the value to a first threshold confidence value, and unlocking platform functionality when the value indicative of the first credential type satisfies the first threshold confidence value.

Example 17 includes the subject matter of example 16, and further includes prohibiting access to platform functionality when the response to the instruction contains a value indicative of a second credential type.

Example 18 includes the subject matter of example 17, and further includes identifying an out-of-order credential violation in response to receiving the second credential type.

Example 19 includes the subject matter of example 16, and further includes comparing a signature embedded in the platform policy sequence with a trusted certificate authority.

Example 20 includes the subject matter of example 19, and further includes decrypting the platform policy sequence using a public key embedded in the platform policy sequence when the trusted certificate authority is included as an authorized certificate authority.

Example 21 includes the subject matter of example 16, and further includes transmitting an instruction for a second one of the credential types associated with a second sequence position of the platform policy sequence in response to confirming satisfaction of the first threshold confidence value.

Example 22 includes the subject matter of example 21, and further includes determining whether a response to the instruction for the second one of the credential types contains a value indicative of the second credential type.

Example 23 includes the subject matter of example 16, and further includes determining whether the response to the instruction is associated with at least one of a fingerprint credential type, an iris credential type, a vein pattern credential type, a password credential type, or a voice recognition credential type.

Example 24 includes the subject matter of example 16, and further includes identifying a request to provide third party credentials to a third party service provider.

Example 25 includes the subject matter of example 24, and further includes transmitting the third party credentials to the third party service provider without participation by an operating system of the platform.

Example 26 includes the subject matter of example 16, and further includes determining if a time limit has expired since the platform functionality was unlocked.

Example 27 includes the subject matter of example 26, and further includes locking the platform and selecting an alternate platform policy sequence when the time limit has expired, the alternate platform policy sequence comprising an alternate first one of the credential types associated with the first sequence position.

Example 28 includes the subject matter of examples 16 to 18, and further includes comparing a signature embedded in the platform policy sequence with a trusted certificate authority, and decrypting the platform policy sequence using a public key embedded in the platform policy sequence when the trusted certificate authority is included as an authorized certificate authority.

Example 29 includes the subject matter of examples 16 to 18, and further includes transmitting an instruction for a second one of the credential types associated with a second sequence position of the platform policy sequence in response to confirming satisfaction of the first threshold confidence value, and determining whether a response to the instruction for the second one of the credential types contains a value indicative of the second credential type.

Example 30 includes a tangible machine readable storage medium having machine readable instructions which, when executed, cause a machine to at least verify whether a platform policy sequence is authorized for the platform, and when the platform policy sequence is authorized, extract an ordered sequence of credential types from the platform policy sequence. Example 30 also includes instructions which, when executed, cause the machine to, in response to a platform log in request, transmit an instruction for a first one of the credential types associated with a first sequence position of the platform policy sequence, to determine whether a response to the instruction contains a value indicative of the first credential type, and when the response contains the value indicative of the first credential type, to compare the value to a first threshold confidence value. The example instructions, when executed, also cause the machine to unlock platform functionality when the value indicative of the first credential type satisfies the first threshold confidence value.

Example 31 includes the subject matter of example 30, and further includes wherein the machine readable instructions, when executed, further cause the machine to prohibit access to platform functionality when the response to the instruction contains a value indicative of a second credential type.

Example 32 includes the subject matter of example 31, and further includes wherein the machine readable instructions, when executed, further cause the machine to prohibit access to platform functionality when the response to the instruction contains a value indicative of a second credential type.

Example 33 includes the subject matter of example 32, and further includes wherein the machine readable instructions, when executed, further cause the machine to identify an out-of-order credential violation in response to receiving the second credential type.

Example 34 includes the subject matter of example 30, and further includes wherein the machine readable instructions, when executed, further cause the machine to compare a signature embedded in the platform policy sequence with a trusted certificate authority.

Example 35 includes the subject matter of example 34, and further includes wherein the machine readable instructions, when executed, further cause the machine to decrypt the platform policy sequence using a public key embedded in the platform policy sequence when the trusted certificate authority is included as an authorized certificate authority.

Example 36 includes the subject matter of example 30, and further includes wherein the machine readable instructions, when executed, further cause the machine to transmit an instruction for a second one of the credential types associated with a second sequence position of the platform policy sequence in response to confirming satisfaction of the first threshold confidence value.

Example 37 includes the subject matter of example 36, and further includes wherein the machine readable instructions, when executed, further cause the machine to determine whether a response to the instruction for the second one of the credential types contains a value indicative of the second credential type.

Example 38 includes the subject matter of example 30, and further includes wherein the machine readable instructions, when executed, further cause the machine to determine whether the response to the instruction is associated with at least one of a fingerprint credential type, an iris credential type, a vein pattern credential type, a password credential type, or a voice recognition credential type.

Example 39 includes the subject matter of example 30, and further includes wherein the machine readable instructions, when executed, further cause the machine to identify a request to provide third party credentials to a third party service provider.

Example 40 includes the subject matter of example 39, and further includes wherein the machine readable instructions, when executed, further cause the machine to transmit the third party credentials to the third party service provider without participation by an operating system of the platform.

Example 41 includes the subject matter of example 30, and further includes wherein the machine readable instructions, when executed, further cause the machine to determine if a time limit has expired since the platform functionality was unlocked.

Example 42 includes the subject matter of example 41, and further includes wherein the machine readable instructions, when executed, further cause the machine to lock the platform and select an alternate platform policy sequence when the time limit has expired, the alternate platform policy sequence comprising an alternate first one of the credential types associated with the first sequence position.

Example 43 includes the subject matter of examples 30-33, and further includes wherein the machine readable instructions, when executed, further cause the machine to compare a signature embedded in the platform policy sequence with a trusted certificate authority, and to decrypt the platform policy sequence using a public key embedded in the platform policy sequence when the trusted certificate authority is included as an authorized certificate authority.

Example 44 includes a system to authenticate a platform, and includes means for verifying whether a platform policy sequence is authorized for the platform, and when the platform policy sequence is authorized, means for extracting an ordered sequence of credential types from the platform policy sequence. The example system also includes, in response to a platform log in request, means for transmitting an instruction for a first one of the credential types associated with a first sequence position of the platform policy sequence, means for determining whether a response to the instruction contains a value indicative of the first credential type, and when the response contains the value indicative of the first credential type, means for comparing the value to a first threshold confidence value, and means for unlocking platform functionality when the value indicative of the first credential type satisfies the first threshold confidence value.

Example 45 includes the subject matter of example 44, and further includes means for prohibiting access to platform functionality when the response to the instruction contains a value indicative of a second credential type.

Example 46 includes the subject matter of example 45, and further includes means for identifying an out-of-order credential violation in response to receiving the second credential type.

Example 47 includes the subject matter of example 44, and further includes means for comparing a signature embedded in the platform policy sequence with a trusted certificate authority.

Example 48 includes the subject matter of example 47, and further includes means for decrypting the platform policy sequence using a public key embedded in the platform policy sequence when the trusted certificate authority is included as an authorized certificate authority.

Example 49 includes the subject matter of example 44, and further includes means for transmitting an instruction for a second one of the credential types associated with a second sequence position of the platform policy sequence in response to confirming satisfaction of the first threshold confidence value.

Example 50 includes the subject matter of example 49, and further includes means for determining whether a response to the instruction for the second one of the credential types contains a value indicative of the second credential type.

Example 51 includes the subject matter of example 44, and further includes means for determining whether the response to the instruction is associated with at least one of a fingerprint credential type, an iris credential type, a vein pattern credential type, a password credential type, or a voice recognition credential type.

Example 52 includes the subject matter of example 44, and further includes means for identifying a request to provide third party credentials to a third party service provider.

Example 53 includes the subject matter of example 52, and further includes means for transmitting the third party credentials to the third party service provider without participation by an operating system of the platform.

Example 54 includes the subject matter of example 44, and further includes means for determining if a time limit has expired since the platform functionality was unlocked.

Example 55 includes the subject matter of example 54, and further includes means for locking the platform and selecting an alternate platform policy sequence when the time limit has expired, the alternate platform policy sequence comprising an alternate first one of the credential types associated with the first sequence position.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus to authenticate a platform, comprising:
a verification engine to verify whether a platform policy sequence is authorized for the platform;
when the platform policy sequence is authorized, a policy sequence engine to extract an ordered sequence of credential types from the platform policy sequence;
in response to a platform log in request, a platform instruction engine to:
transmit an instruction for a first one of the credential types associated with a first sequence position of the platform policy sequence;
determine whether a response to the instruction contains a value indicative of the first credential type; and
when the response contains the value indicative of the first credential type, comparing the value to a first threshold confidence value; and
a platform authorization engine to unlock platform functionality when the value indicative of the first credential type satisfies the first threshold confidence value.

2. An apparatus as defined in claim 1, wherein the platform instruction engine is to prohibit access to platform functionality when the response to the instruction contains a value indicative of a second credential type.

3. An apparatus as defined in claim 2, wherein the platform instruction engine is to identify an out-of-order credential violation in response to receiving the second credential type.

4. An apparatus as defined in claim 1, wherein the verification engine is to compare a signature embedded in the platform policy sequence with a trusted certificate authority.

5. An apparatus as defined in claim 4, wherein the verification engine is to decrypt the platform policy sequence using a public key embedded in the platform policy sequence when the trusted certificate authority is included as an authorized certificate authority.

6. An apparatus as defined in claim 1, wherein the platform instruction engine is to transmit an instruction for a second one of the credential types associated with a second sequence position of the platform policy sequence in response to confirming satisfaction of the first threshold confidence value.

7. An apparatus as defined in claim 6, wherein the platform instruction engine is to determine whether a response to the instruction for the second one of the credential types contains a value indicative of the second credential type.

8. An apparatus as defined in claim 1, wherein the platform instruction engine is to determine whether the response to the instruction is associated with at least one of a fingerprint credential type, an iris credential type, a vein pattern credential type, a password credential type, or a voice recognition credential type.

9. An apparatus as defined in claim 1, wherein the platform authorization engine is to identify a request to provide third party credentials to a third party service provider.

10. An apparatus as defined in claim 9, wherein the platform authorization engine is to transmit the third party credentials to the third party service provider without participation by an operating system of the platform.

11. An apparatus as defined in claim 1, wherein the platform authorization engine is to determine if a time limit has expired since the platform functionality was unlocked.

12. An apparatus as defined in claim 11, wherein the platform authorization engine is to lock the platform and select an alternate platform policy sequence when the time limit has expired, the alternate platform policy sequence comprising an alternate first one of the credential types associated with the first sequence position.

13. A method to authenticate a platform, comprising:
verifying whether a platform policy sequence is authorized for the platform;
when the platform policy sequence is authorized, extracting an ordered sequence of credential types from the platform policy sequence;
in response to a platform log in request:
transmitting an instruction for a first one of the credential types associated with a first sequence position of the platform policy sequence;
determining whether a response to the instruction contains a value indicative of the first credential type; and
when the response contains the value indicative of the first credential type, comparing the value to a first threshold confidence value; and
unlocking platform functionality when the value indicative of the first credential type satisfies the first threshold confidence value.

14. A method as defined in claim 13, further comprising prohibiting access to platform functionality when the response to the instruction contains a value indicative of a second credential type.

15. A method as defined in claim 14, further comprising identifying an out-of-order credential violation in response to receiving the second credential type.

16. A method as defined in claim 13, further comprising comparing a signature embedded in the platform policy sequence with a trusted certificate authority.

17. A method as defined in claim 16, further comprising decrypting the platform policy sequence using a public key embedded in the platform policy sequence when the trusted certificate authority is included as an authorized certificate authority.

18. A method as defined in claim 13, further comprising transmitting an instruction for a second one of the credential types associated with a second sequence position of the platform policy sequence in response to confirming satisfaction of the first threshold confidence value.

19. A method as defined in claim 18, further comprising determining whether a response to the instruction for the second one of the credential types contains a value indicative of the second credential type.

20. A method as defined in claim 13, further comprising determining whether the response to the instruction is associated with at least one of a fingerprint credential type, an iris credential type, a vein pattern credential type, a password credential type, or a voice recognition credential type.

21. (canceled)

22. (canceled)

23. (canceled)

24. (canceled)

25. A tangible machine readable storage medium comprising machine readable instructions which, when executed, cause a machine to at least:
verify whether a platform policy sequence is authorized for the platform;
when the platform policy sequence is authorized, extract an ordered sequence of credential types from the platform policy sequence;
in response to a platform log in request:
transmit an instruction for a first one of the credential types associated with a first sequence position of the platform policy sequence;
determine whether a response to the instruction contains a value indicative of the first credential type; and
when the response contains the value indicative of the first credential type, compare the value to a first threshold confidence value; and
unlock platform functionality when the value indicative of the first credential type satisfies the first threshold confidence value.

26. A storage medium as defined in claim 25, wherein the machine readable instructions, when executed, further cause the machine to prohibit access to platform functionality when the response to the instruction contains a value indicative of a second credential type.

27. A storage medium as defined in claim 26, wherein the machine readable instructions, when executed, further cause the machine to prohibit access to platform functionality when the response to the instruction contains a value indicative of a second credential type.

28. A storage medium as defined in claim 27, wherein the machine readable instructions, when executed, further cause the machine to identify an out-of-order credential violation in response to receiving the second credential type.

29. A storage medium as defined in claim 25, wherein the machine readable instructions, when executed, further cause the machine to compare a signature embedded in the platform policy sequence with a trusted certificate authority.

30. (canceled)

31. (canceled)

32. (canceled)

33. (canceled)

34. (canceled)

35. (canceled)

36. (canceled)

37. (canceled)
